(19) United States
(12) Patent Application Publication
(10) Pub. No.: US 2013/0075572 A1
(43) Pub. Date: Mar. 28, 2013

(54) STRUCTURE FOR MOUNTING ELECTRIC VACUUM PUMP

(71) Applicants: Yoshihiro Matsumoto, Shizuoka-ken (JP); Daisuke Hirose, Shizuoka-ken (JP)

(72) Inventors: Yoshihiro Matsumoto, Shizuoka-ken (JP); Daisuke Hirose, Shizuoka-ken (JP)

(73) Assignee: SUZUKI MOTOR CORPORATION, SHIZUOKA-KEN (JP)

(21) Appl. No.: 13/702,495

(22) PCT Filed: Mar. 7, 2011
(86) PCT No.: PCT/JP2011/055233

§ 371 Date: Dec. 6, 2012

(30) Foreign Application Priority Data
Jun. 18, 2010 (JP) 2010-138976

(51) Int. Cl. F16M 13/02

(52) U.S. Cl. CPC F16M 13/02
USPC 248/560

(57) ABSTRACT

In a structure for mounting an electric vacuum pump 1 to a vehicle body frame 3 via a bracket 2, the bracket 2 includes a wobble suppression portion 2F that is formed so as to surround a portion of the electric vacuum pump 1 at a position vertically apart from a pump mounting portion 2B, and a wobble prevention mount 5 that suppresses wobbling of the electric vacuum pump 1 in abutment against the electric vacuum pump 1 is mounted to the wobble suppression portion 2F.

### TECHNICAL FIELD

The present invention relates to a structure for mounting an electric vacuum pump to a vehicle body frame via a bracket.

### BACKGROUND ART

For example, in hybrid vehicles which use an engine and an electric motor in combination as a driving source, an intake vacuum of the engine cannot be supplied to a brake booster while the hybrid vehicles are running by the electric motor, so that an electric vacuum pump is provided and a vacuum is supplied to the brake booster by driving the electric vacuum pump when the engine is stopped.

While the electric vacuum pump is mounted to a vehicle body frame via a bracket in an engine compartment, the durability of the electric vacuum pump is improved by providing a rubber mount between the said electric vacuum pump and the bracket, and absorbing engine vibrations or vibrations of a vehicle body during running by the rubber mount to suppress propagation of the vibrations to the electric vacuum pump, and quietness in a vehicle cabin is ensured by suppressing propagation of vibrations of the electric vacuum pump during driving to the vehicle body.

Meanwhile, as a structure for mounting the electric vacuum pump, Patent Literature 1 has proposed a configuration in which a mounting hole having a larger diameter than an electric vacuum pump is formed in a bracket, a longitudinally-disposed electric vacuum pump is inserted into the mounting hole, and a flange portion of the electric vacuum pump is mounted onto a boss portion that is vertically provided on the bracket to cause the electric vacuum pump to project with a small height on the bracket.

### CITATION LIST

### Patent Literature

[PTL 1]

Japanese Utility Model Publication No. 7-023325

### SUMMARY OF INVENTION

### Technical Problem

While the electric vacuum pump is mounted to the bracket via the rubber mount as described above, the rubber mount for mounting may not fully absorb the vibrations of the vehicle body or the engine in some cases, and in such a case, the electric vacuum pump wobbles around the rubber mount. When the electric vacuum pump wobbles as described above, excessive load is applied to the rubber mount, the bracket, a mounting bolt or the like, so there may occur a problem in the durability thereof, and there may also occur a problem in that the electric vacuum pump cannot exert its original performance.

The present invention has been made in view of the problems, and an object thereof is to provide a structure for mounting an electric vacuum pump which can reduce load acting on a rubber mount, a bracket or the like by regulating wobbling of the electric vacuum pump, and which can prevent a deterioration in performance of the electric vacuum pump.

### Solution to Problem

To achieve the object, the present invention is featured in a structure for mounting an electric vacuum pump to a vehicle body frame via a bracket, wherein the bracket includes a pump mounting portion to which the electric vacuum pump is mounted, and a wobble suppression portion that is formed so as to surround a portion of the electric vacuum pump at a position vertically apart from the pump mounting portion, and a wobble prevention mount that suppresses wobbling of the electric vacuum pump in abutment against the electric vacuum pump is mounted to the wobble suppression portion.

Also, in a preferred aspect of the present invention, an upper portion of the electric vacuum pump is mounted to the pump mounting portion of the bracket with the electric vacuum pump being longitudinally oriented, a lower end portion of the electric vacuum pump is inserted into the wobble suppression portion, and the wobble prevention mount comprises a plurality of wobble prevention mounts arranged circumferentially apart from each other.

Moreover, in another preferred aspect of the present invention, the pump mounting portion is formed in the bracket so as to project in a bifurcated manner, and the electric vacuum pump is located therebetween and is mounted via a rubber mount on each side.

### Advantageous Effects of Invention

In the present invention, with the configuration, since the wobble prevention mount attached to the wobble suppression portion of the bracket suppresses the wobbling in abutment against the electric vacuum pump even when the electric vacuum pump is to wobble around the pump mounting portion of the bracket, the wobbling of the electric vacuum pump is suppressed, and load acting on the rubber mount provided in the mounting portion of the said electric vacuum pump to the bracket, the bracket or the like is reduced, so that the durability thereof is improved. Also, since the wobbling of the electric vacuum pump is suppressed, interference between the said wobbling vacuum pump and peripheral parts is prevented, the electric vacuum pump can be arranged adjacent to the peripheral parts, and a deterioration in performance resulting from the wobbling of the electric vacuum pump can be prevented.

Also, with the preferred aspect of the present invention, since the electric vacuum pump is mounted in a state in which the upper portion thereof is suspended by the bracket in a longitudinally-disposed state and the wobble suppression portion of the bracket does not need to support the electric vacuum pump, vibration propagation to the electric vacuum pump can be suppressed by using a soft material with high vibration absorption capacity for the wobble prevention mounts.

Furthermore, in another preferred aspect of the present invention, since the electric vacuum pump is located between the pump mounting portions projecting in a bifurcated manner and is mounted via the rubber mount on each side, the assembling operability of the electric vacuum pump is improved.

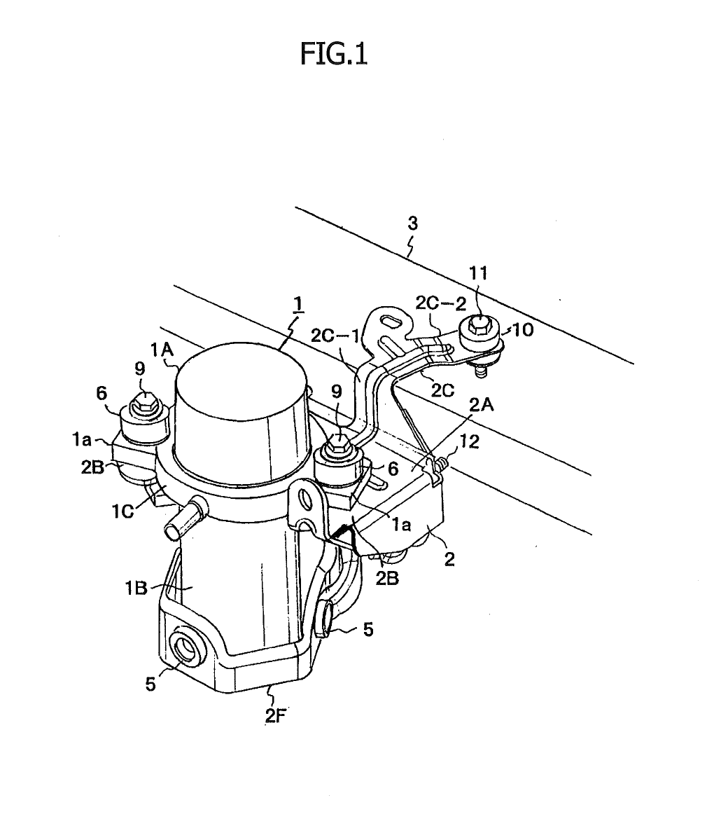

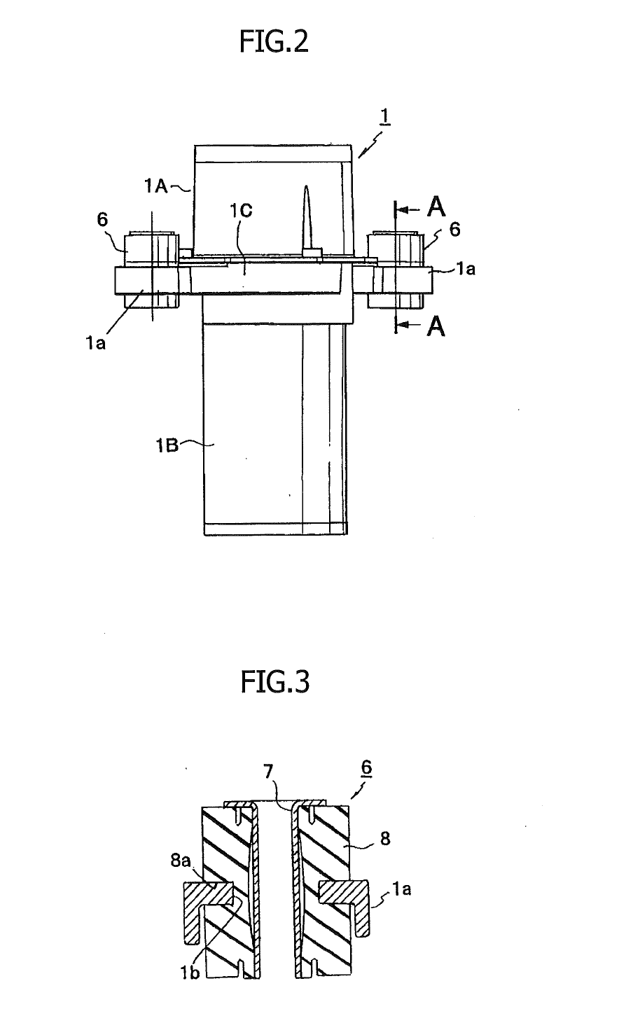

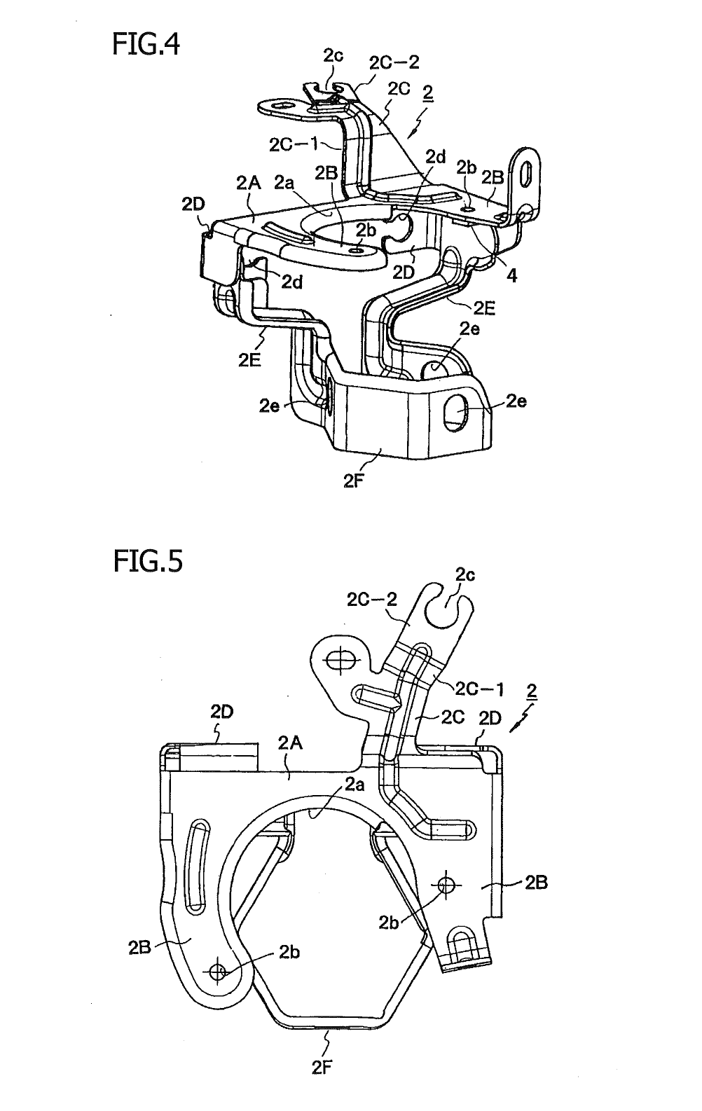

### BRIEF DESCRIPTION OF DRAWINGS

[FIG. 1] FIG. 1 is a perspective view illustrating a structure for mounting an electric vacuum pump according to the present invention.

[FIG. 2] FIG. 2 is a side view of the electric vacuum pump.

[FIG. 3] FIG. 3 is a sectional view along a line A-A of FIG. 2.

[FIG. 4] FIG. 4 is a perspective view of a bracket.

[FIG. 5] FIG. 5 is a plan view of the bracket.

### DESCRIPTION OF EMBODIMENTS

In the following, an embodiment of the present invention will be described based on the accompanying drawings.

FIG. 1 is a perspective view illustrating a structure for mounting an electric vacuum pump according to the present invention, FIG. 2 is a side view of the electric vacuum pump, FIG. 3 is a sectional view along a line A-A of FIG. 2, FIG. 4 is a perspective view of a bracket, and FIG. 5 is a plan view of the same bracket.

An electric vacuum pump 1 shown in FIG. 1 is arranged in an engine compartment of, for example, a hybrid vehicle which uses an engine and an electric motor in combination as a driving source, and is mounted to a vehicle body frame 3 via a bracket 2.

Here, the bracket 2 is a press molding of sheet metal, and as shown in FIGS. 4 and 5, a semicircular cutout 2a which is opened on a side, the opposite side to the vehicle body frame 3, is formed in a horizontal upper wall 2A thereof, and pump mounting portions 2B that project toward the side, the opposite side to the vehicle body frame 3 in a bifurcated manner, are formed on both sides of the cutout 2a. Circular holes 2b are respectively formed in each of the pump mounting portions 2B formed in the upper wall 2A of the bracket 2, and welding nuts 4 (only one of which is shown in FIG. 4) are welded to the peripheries of the respective circular holes 2b on a lower surface of the upper wall 2A.

Also, an arm portion 2C is integrally provided extending along the shape of the vehicle body frame 3 from an edge portion of the upper wall 2A of the bracket 2 on the vehicle body frame 3 side, a vertical portion 2C-1 vertically rising along a side wall of the vehicle body frame 3 and a horizontal portion 2C-2 along an upper surface of the vehicle body frame 3 are formed in the arm portion 2C as shown in FIG. 1, and a partially-removed circular hole 2c is formed in the horizontal portion 2C-2. A side wall 2D that is bent downward at a right angle from a peripheral edge of the upper wall 2A to extend along the side wall of the vehicle body frame 3 is formed in the bracket 2 on a side where the arm portion 2C is provided (on the vehicle body frame 3 side), and partially-removed circular holes 2d (only one of which is shown in FIG. 4) are formed in the side wall 2D. To be more specific, the side wall 2D is formed at two positions by bending downward the respective pump mounting portions 2B that project in a bifurcated manner from an end edge on the opposite side to the cutout 2a and curving an end edge of each bent portion on the vehicle body frame 3 side along the side wall of the vehicle body frame 3. The partially-removed circular holes 2d that are cut out in different directions are formed in the respective side walls 2D.

Furthermore, a wobble suppression portion 2F is formed below the upper wall 2A of the bracket 2 with a distance from the upper wall 2A. The wobble suppression portion 2F has a frame-like shape having a substantially-hexagonal shape in plan view (more specifically, a shape arranged in a frame-like manner at positions corresponding to five sides out of the six sides of a regular hexagon), stays 2E that are provided extending upward from the substantially-hexagonal shape vertically extend, and the stays 2E are connected to the bent portions bent downward from the end edge of the upper wall 2A of the bracket 2. Here, the substantially-hexagonal shape of the wobble suppression portion 2F is formed concentrically with the cutout 2a below the cutout 2a (a position downwardly apart from the pump mounting portions 2B formed in the upper wall 2A) formed in the upper wall 2A as shown in FIG. 5, and an inscribed circle diameter of the said wobble regulation portion 2F and an inner diameter of the cutout 2a are both set to be larger than an outer diameter of a lower half portion 1B of the electric vacuum pump 1.

A long hole 2e that is long in the vertical direction is formed in each of three alternate sides out of the six sides of the hexagon of the wobble regulation portion 2F formed at a lower end portion of the bracket 2, and as shown in FIG. 1, a wobble prevention mount 5 is inserted and attached to each of the long holes 2e.

On the other hand, the electric vacuum pump 1 has a cylindrical shape as shown in FIG. 2, mounting brackets 1a horizontally extend to a radial outer side from right and left two positions of a flange portion 1C that is formed in a flange shape on the outer periphery of an upper portion thereof, and rubber mounts 6 are respectively inserted and fixed to each of the mounting brackets 1a. Here, each of the rubber mounts 6 is provided by fixing a cylindrical rubber grommet 8 to the outer periphery of a metal collar 7 by baking or the like as shown in FIG. 3, and the rubber mount 6 is inserted and fixed to the mounting bracket 1a as described above by fitting a peripheral edge of a slit 1b formed in the mounting bracket 1a of the electric vacuum pump 1 so as to be opened toward the radial outer side into a fitting groove 8a formed in the outer periphery of the rubber grommet 8.

Accordingly, the electric vacuum pump 1 is vertically supported by the bracket 2 by inserting the lower half portion 1B thereof into the cutout 2a and the wobble regulation portion 2F of the bracket 2 from above with the axis of the cylindrical shape thereof being in a longitudinally-oriented state, and placing the two rubber mounts 6 on the pair of pump mounting portions 2B formed in the upper wall 2A of the bracket 2. In this state, as shown in FIG. 1, an upper half portion 1A of the electric vacuum pump 1 projects vertically upward from the upper wall 2A of the mounting bracket 2, and the lower half portion 1B has its periphery surrounded by the hexagonal frame-like wobble regulation portion 2F formed at the lower end portion of the bracket 2. Also, the three wobble prevention mounts 5 attached to the wobble regulation portion 2F of the bracket 2 face the outer periphery of the lower half portion 1B of the electric vacuum pump 1 with a predetermined gap being ensured therebetween.

As described above, the electric vacuum pump 1 is mounted to the bracket 2 via the rubber mounts 6 in a longitudinally-disposed state by placing the two rubber mounts 6 attached to the electric vacuum pump 1 respectively on the pair of pump mounting portions 1B formed in the bracket 2 to thereby support the electric vacuum pump 1 from below by the upper wall 2A of the bracket 2 in a vertically-suspended state, fitting the collars 7 of the respective rubber mounts 6 with the circular holes 2b formed in the respective pump mounting portions 2B of the bracket 2, inserting bolts 9 inserted through the collars 7 from above into the circular holes 2b formed in the respective pump mounting portions 2B of the bracket 2, and screwing end portions thereof into the welding nuts 4 welded to the lower surfaces of the pump mounting portions 2B of the bracket 2.

The bracket 2 to which the electric vacuum pump 1 is mounted to the upper surface of the vehicle body frame 3 at one point by fitting a rubber bush 10 into the partially-removed circular hole 2c formed at a distal end of the arm portion 2C, and fastening a bolt 11 inserted through the rubber bush 10 from above onto the upper surface of the vehicle body frame 3 as shown in FIG. 1. Also, the bracket 2 is fixed to a side surface of the vehicle body frame 3 at two points by respectively fitting rubber bushes, not shown, into the partially-removed circular holes 2d formed in the side walls 2D of the bracket 2, and screwing bolts 12 (only one of which is shown in FIG. 1) inserted laterally through the respective rubber bushes into the side surface of the vehicle body frame 3. Therefore, the bracket 2 is fixed to the upper surface and the side surface of the vehicle body, frame 3 at three positions, and the three points are fixed to the vehicle body frame 3 via the rubber bush 10 (the other two are not shown). That is, the electric vacuum pump 1 is mounted to the bracket 2 via the rubber mounts 6, and the bracket 2 is fixed to the vehicle body frame 3 via the rubber bushes 10, so that propagation of vibrations between the electric vacuum pump 1 and a vehicle body can be suppressed.

Accordingly, the electric vacuum pump 1 mounted to the vehicle body frame 3 via the bracket 2 as described above is driven with a battery as a power source in a case in which an intake vacuum of the engine cannot be used as an assist force of a brake since the engine is stopped, and a vacuum generated by the said electric vacuum pump 1 is supplied to a brake booster.

As described above, in the present embodiment, even when the electric vacuum pump 1 is to wobble around the pump mounting portions 2B (the rubber mounts 6) of the bracket 2 due to vibrations of the engine or the vehicle body or the like, the three wobble prevention mounts 5 attached to the wobble suppression portion 2F of the bracket 2 that surrounds the periphery of the lower half portion 1B of the said electric vacuum pump 1 are brought into abutment against the outer periphery of the lower half portion 1B of the electric vacuum pump 1 to suppress the wobbling. Therefore, the wobbling of the electric vacuum pump 1 is suppressed, load acting on the rubber mounts 6 provided in the mounting portion of the said electric vacuum pump 1 to the bracket 2, the bracket 2 or the like is reduced, and the durability thereof is improved.

Also, since the wobbling of the electric vacuum pump 1 is suppressed by the wobble prevention mounts 5 as described above, interference between the said electric vacuum pump 1 and peripheral parts is prevented, so that the electric vacuum pump 1 can be arranged adjacent to the peripheral parts, a deterioration in performance resulting from the wobbling of the electric vacuum pump 1 can be prevented, and the said electric vacuum pump 1 can thus fully exert its original performance.

Moreover, since the electric vacuum pump 1 is mounted in a state in which the upper portion is suspended by the bracket 2 in the longitudinally-disposed state and the wobble suppression portion 2F of the bracket 2 does not need to support the electric vacuum pump 1, the vibration propagation to the electric vacuum pump 1 can be suppressed by using a soft material with high vibration absorption capacity for the wobble prevention mounts 5.

In addition, in the present embodiment, the pump mounting portions 2B projecting in a bifurcated manner are formed in the bracket 2, the electric vacuum pump 1 is inserted into the semicircular cutout 2a formed between the said pump mounting portions 2B, and the mounting portions of the said electric vacuum pump 1 are mounted to the pump mounting portions 2B of the bracket 2 via the rubber mounts 6, so that there is also an effect that the assembling operability of the electric vacuum pump 1 is improved.

Although the structure for mounting the electric vacuum pump in the hybrid vehicle which uses the engine and the electric motor in combination as the driving source has been described above, the present invention can be, of course, similarly applied to a structure for mounting an electric vacuum pump provided in electric cars which run by using only an electric motor as a driving source.

### REFERENCE SIGNS LIST

1 Electric vacuum pump
1A Upper half portion of the electric vacuum pump
1B Lower half portion of the electric vacuum pump
2 Bracket
2A Upper wall of the bracket
2B Pump mounting portion of the bracket
2C Arm portion of the bracket
2D Side wall of the bracket
2E Stay of the bracket
2F Wobble suppression portion of the bracket
2a Cutout of the bracket
3 Vehicle body frame
5 Wobble prevention mount
6 Rubber mount
9 Bolt
10 Rubber bush
11, 12 Bolt

1. A structure for mounting an electric vacuum pump to a vehicle body frame via a bracket, the bracket comprising:
a pump mounting portion to which the electric vacuum pump is mounted; and
a wobble suppression portion that is formed so as to surround a portion of the electric vacuum pump at a position vertically apart from the pump mounting portion,
wherein a wobble prevention mount that suppresses wobble of the electric vacuum pump in abutment against the electric vacuum pump is attached to the wobble suppression portion.

2. The structure for mounting an electric vacuum pump according to claim 1, wherein an upper portion of the electric vacuum pump is mounted to the pump mounting portion of the bracket with the electric vacuum pump being longitudinally oriented, a lower end portion of the electric vacuum pump is inserted into the wobble suppression portion, and the wobble prevention mount comprises a plurality of wobble prevention mounts arranged circumferentially apart from each other.

3. The structure for mounting an electric vacuum pump according to claim 1, wherein the pump mounting portion is formed in the bracket so as to project in a bifurcated manner, and the electric vacuum pump is located therebetween and is mounted via a rubber mount on each side.

4. The structure for mounting an electric vacuum pump according to claim 2, wherein the pump mounting portion is formed in the bracket so as to project in a bifurcated manner, and the electric vacuum pump is located therebetween and is mounted via a rubber mount on each side.
